(19) United States
(12) Patent Application Publication
(10) Pub. No.: US 2008/0014480 A1
(43) Pub. Date: Jan. 17, 2008

(54) Fuel gas generation and supply device

(76) Inventor: Koji Kobayashi, Aichi (JP)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/726,999

(22) Filed: Mar. 23, 2007

(30) Foreign Application Priority Data
Mar. 24, 2006 (JP) 2006-082505

(51) Int. Cl. H01M 8/06

(52) U.S. Cl. 429/19

(57) ABSTRACT

Problem: The fuel supply means for small fuel cells, including portable ones, must be of a small size that permits portable applications, be lightweight and be given a constant chemical reaction rate when fuel gas is continuously generated and supplied in a constant amount by a chemical reaction means. Solution: The problem described above was solved by making the chemical reaction concentration in the chemical reaction space universal over time by supplying the chemical reaction solution supplied at a constant rate and providing a first chemical reaction space where there is minimization for that reaction rate and a second chemical reaction space linked thereto. Furthermore, for simplification and size reduction, the second chemical reaction space is housed in a space linked to a solution storage space for at least one of the first and second above.

### FIELD OF THE INVENTION

The present invention relates to a gas generation and supply device for small fuel cells that makes the chemical reaction rate constant and continuously supplies a constant amount of fuel gas.

### BACKGROUND OF THE INVENTION

Various storage and supply methods have been developed and proposed up to this point as fuel supply means for portable or stationary fuel cells. One attempt, a fuel supply means that makes use of a chemical reaction aimed at practical applications has come to be widely proposed as a lightweight, inexpensive method where the amount of fuel storage is greater than other methods. However, there is an urgent need for making the chemical reaction rate constant and making a device that continuously provides a stable supply of fuel gas in a constant quantity with a small inexpensive structure that can be made portable.

[Patent References 1] Published Unexamined Patent Application No. 2005-19517, Published Unexamined Patent Application No. 200-93104, Published Unexamined Patent Application No. 2004-318683, Published Unexamined Patent Application No. 2000-161509, Patent Application 2005-321503.

[Non-Patent Reference 1] Nikkei Electronics, Jun. 6, 2005, No. 901 “Borohydride Enters the Fray for Portable Fuel Cells

### DISCLOSURE OF THE INVENTION

[Problems to be Solved by the Invention]

To make the fuel supply stable using a small, simple and inexpensive structure when the fuel cell output is, for example, for applications that are under several lots to applications out of several kilowatts:

The first problem is the necessity for stabilizing the reaction rate by having a constant concentration for the solution at the site of the chemical reaction without its becoming diluted as the reaction progresses over time.

The second problem is the problem of achieving an inexpensive, safe supply device with a small, simple structure capable of being used in portable and stationary applications aimed at popularization.

### SUMMARY OF THE INVENTION

To solve the problems above, a first aspect of the invention is a gas generation and supply device comprising a first chemical reaction space for continuously generating a constant amount of fuel gas by a chemical reaction through the mixing of a solution supplied by a first constant solution supply means and a particulate material and a second chemical reaction space linked to that first chemical reaction space. To make rate of dilution of the chemical reaction solution concentration with the passage of time slow, the volume of the first chemical reaction space is smaller than that of the solution supply means.

The second aspect of the invention is the gas generation and supply device wherein a supply outlet for the solution supply means is provided with the particulate material around it in a position separated from a communicating opening and the central part of the first chemical reaction space and is set so that the supply solution does not flow into the communicating opening directly while it is insufficient for the chemical reaction.

The third aspect of the invention is the gas generation and supply device wherein the particulate material is housed in a material provided with at least a partial opening and formed from at least one other material having solution permeability, the contact with the solution supplied being restricted and there being a structure that prevents early dissolution of the particulate material.

The fourth aspect of the invention is the gas generation and supply device wherein, even when a second solution that produces the fuel gas by a chemical reaction is used instead of the particulate material, the first chemical reaction space, which is capable of a constant rate chemical reaction, and the second chemical reaction space linked to that space are provided, and the first chemical reaction space is smaller in volume than the solution supply means.

The fifth aspect of the invention is the gas generation and supply device wherein there is provided a material that adsorbs the solution and maintains the concentration of the solution to keep the solution for the chemical reaction in the first chemical reaction space so that the chemical reaction is insufficient by diffusion in a mobile state, particularly when it is portable.

The sixth aspect of the invention is the gas generation and supply device wherein there is provided the first reaction space and the second reaction space regardless of whether the chemical reaction for producing the fuel gas is the solution and the particulate material or a mixture of two different solutions. The first chemical reaction space has a space size that corresponds to the chemical reaction rate, and the concentration of the solution supplied at a constant rate by the solution supply means is made constant.

The seventh aspect of the invention is the gas generation and supply device made simpler and smaller with the second chemical reaction space disposed within a storage body along with the solution supply means.

### ADVANTAGE OF THE INVENTION

According to the first through sixth aspects of the invention, it is possible to make the chemical reaction rate constant when portable even in a state of mobile use regardless of the chemical reaction being from the solution and particulate material or from two different solutions, and a continuous supply of a constant amount of fuel gas to the fuel cell is achieved by the same concept. Furthermore, the fuel supply pressure adjustment valve that was necessary when fuel was supplied by a high-pressure tank storing a metal hydride has been made unnecessary by the present invention.

According to the seventh aspect of the invention, it is possible to use a reduced space for the solution supply by disposing the second chemical reaction space in the storage body along with the solution supply means. There is no need to provide a new space, and compactness and reduced weight may be achieved.

### DESCRIPTION OF THE PREFERRED EMBODIMENTS

In the following, embodiments of the present invention will be described based on the drawings

FIG. 1 is a block diagram of a hydrogen gas generation and supply device that generates and supplies hydrogen gas by a chemical reaction to supply fuel gas to a small, portable fuel cell, for example, in a first embodiment of the present invention.

The gas generation and supply device of the present invention comprises three parts, a storage body 3 housing a solution storage body 1 and a first chemical reaction space 30 and a second chemical reaction space 15. In the solution storage body 1, for example, a hydrogen resistant fluorine based rubber balloon 14 housing a body (for example, a body partially or completely transparent to a small volume of hydrogen gas at a low pressure of approximately 0.1 Pa or less) 11 and a solution (for example, an aqueous solution of malic acid or hydrochloric acid) adjusted in advance to a prescribed concentration) 10 is linked to a first reaction space 30 through a supply opening 10a, and the solution 10 may be continuously supplied by a supply opening 10b to the reaction space 30 at a constant rate. A second reaction space 15 and the balloon 14 are housed together in a gas permeable material (for example, a carbon cloth, Gortex or the like, prevents liquid from passing through) 13, and compactness may be enhanced. The outer periphery of the second reaction space 15 is provided with a gas flow space 12 that is linked to a gas outlet 300.

The storage body 3 houses a particulate material (for example, specially processed aluminum alloy, borohydride, or the like) 20 that produces a chemical reaction when in contact with the solution 10 and generates the fuel gas. The solution 10 is continuously supplied to the particulate material 20 from the supply opening 10b at a constant rate, and the fuel gas is continuously generated by a constant rate by the chemical reaction. The size of the storage body 3 for the first chemical reaction space 30 is set so that there is no dilution of the solution concentration with the progress of the chemical reaction over time, and it is smaller than the volume of the solution storage body 1. The chemical reaction solution further flows into the second chemical reaction space 15 through a linking opening 16, and more gas is continuously generated here. It passes through the gas permeable material 13 and is supplied in a constant amount to the fuel cell from the gas flow space 12 and 300.

FIG. 2 is a block diagram of a hydrogen gas generation and supply device of a second embodiment of the present invention. The storage body 3 for the first chemical reaction space 3 of this second embodiment has the gas flow space 12 moved into the first storage body 3 as a flow space 30a. Therefore, the function is the same, the same parts given the same element numbers, and duplicate descriptions omitted.

FIG. 3 is a block diagram of a hydrogen gas generation and supply device of a third embodiment of the present invention. This third embodiment has a constitution where the particulate material 20 shown in FIGS. 1 and 2 above makes contact with the solution 10 through a material 38 that limits the contact to part of the surface area. The material 38 is connected to a part that limits the infiltration rate of the solution 10 and at least one storage material having an opening in one part. Direct contact to the entire surface of the particulate material 20 is prevented, and the rate of contact with the solution 10 may be matched to the rate of the chemical reaction. Therefore, the constitution of the first solution storage body 1 is the same as the constitution of the solution storage body 1 in the first embodiment, the same parts given the same element numbers, and duplicate descriptions omitted.

FIG. 4 is a block diagram of a hydrogen gas generation and supply device of a fourth embodiment of the present invention. The fourth embodiment is a device that brings about the chemical reaction and generates the gas by mixing with a second solution 20 having a prescribed concentration instead of the particulate material 20 shown in FIG. I above with the first solution 10. Therefore, the constitution of the body 1 for the first solution storage is the same as the constitution of the solution storage body 1 in the first embodiment, the same parts given the same element numbers, and duplicate descriptions omitted.

The constitution of a second solution storage body 2 is that of the solution storage body 1 and the functions thereof are the same. Therefore, the corresponding parts are each given corresponding element numbers (the one's digit being the same), and duplicate descriptions are omitted.

When the first and second solutions 10 and 20 are supplied to the first chemical reaction space 30 from supply openings 10a and 20a, respectively, at a constant rate, the chemical reaction occurs, and the fuel gas is generated continuously. As is shown in FIG. 4, this is an example where the middle of the storage body 3 of the first chemical reaction space 30 is provided with a material 33a with good permeability to carry out the reaction with the first and second solution storage body solution concentrations in a constant state. The storage body 3 of the first chemical reaction space 30 and the second chemical reaction spaces 15 and 25 is the same as in embodiment 1, so duplicate descriptions are omitted.

FIG. 5 is a block diagram of a hydrogen gas generation and supply device of a fifth embodiment of the present invention. The storage body 3 for the first chemical reaction space 30 in the fifth embodiment collects gas permeable materials 13 and 23 in FIG. 4 into one as a gas flow space 13 in the space 30 in FIG. 5 as with the storage body 3 for the first chemical reaction space 30 in FIG. 2. Therefore, the function is the same, the corresponding parts each given corresponding element numbers (the one's digit being the same), and duplicate descriptions omitted.

FIG. 6 is a cross-sectional view of a hydrogen gas generation and supply device of a sixth embodiment of the present invention. This cross-sectional view shows the structural example in the FIG. 3 block diagram. In the solution storage body 1, the solution 10 having a prescribed concentration is stored in the balloon 14, affixed to 17c by a ring 14a, and the solution is supplied from the supply opening 10b at a constant rate to the storage body 3 for the first chemical reaction space 30 through a check valve 17.

In the storage body 3 for the first chemical reaction space 30, a shaft pushes a ball 17a up from a seat 17d by checking the solution storage body 1 and a screw 34, and the solution 10 is supplied at a constant rate from an outflow opening 10b provided deep in the center part of the chemical reaction space 30 via a narrowed part 17b formed from at least one indented part, from an inflow opening 10a and the pipe 17c. While producing the chemical reaction with the particulate material 20 at a constant rate, this supplied solution 10 flows toward the chemical reaction space on the side of a linking pipe 16 side and flows into the second chemical reaction space 15. Furthermore, in this FIG. 6, quick dissolving of the particulate material 20 through complete surface contact with the solution 10 is prevented, the storage position thereof stabilized and scattering of the particulate material 20 prevented even in usage states with the particulate material 20 at the various angles of portable use. The particulate material 20 is housed in materials 38 and 38a that limit the contact with the solution 10 to make the chemical reaction continuous at a constant rate. The material 38 prevents infiltration of the solution 10, and the material 38a provides permeability for the solution 10, only allowing a partial contact surface for the particulate material 20 with the solution 10, and the contact surface of the particulate material 20 is adjusted according the chemical reaction rate. The chemical reaction solution that flows into the second chemical reaction space 15 generates more gas in that space, and it flows through the gas permeable material 13 into the gas flow space 12 and is supplied in a constant amount to the fuel cell from the outlet 300 through via paths 16c, 33d and 32. Since a structural material 13a within the solution storage part 1 maintains the shape of the gas permeable material 13, it is supported by a case 11 via a circular member 13b that provides a gas path on the outer periphery.

The storage body for the solution storage body 1 and the first chemical reaction space 30 is sealed from the outside by a sealing material 37b, and the first and second chemical reaction spaces 30 and 15 are sealed when the screw 34 is shut, with the chemical reaction solution only able to flow through the through hole 16. When the solution storage body 1 and the first chemical reaction space 30 are present independently, the storage body 3 for them is affixed and held by the screw 34 using a gap provided with a seal plug for each so that the stored solution and particulate material do not leak. A gas permeable material 33 shaped by a structural material 33a in the same manner as the solution storage body 1 is provided in the storage body 3 for the first chemical reaction space 30, with passage through a gas outlet 36, but the structural member 33a is unnecessary.

FIG. 7 is a cross-sectional view of a hydrogen gas generation and supply device of a seventh embodiment of the present invention. This seventh embodiment shows the structural example for the FIG. 4 block diagram. As with FIG. 6 and the FIG. 4 block diagram, the corresponding parts in this structure are given the same element numbers and duplicate descriptions are omitted.

The storage body for the first chemical reaction space 30 in this FIG. 7 is provided with an H-shaped structural material 33a formed with one, two or more holes 33b, and the constitution is such that at the periphery thereof there is an enclosure 31 provided with the gas outlet 36 via the gas permeable material 33, gas transmission opening 33d and gas flow space 32. The first and second chemical reaction solution storage bodies 1 and 2 and the first chemical reaction space 30 storage body 3 are sealed by seals 37a and 37b. The solutions 10 and 20 from the balloons 14 and 24 are supplied at a constant rate in the first chemical reaction space 30 and mixed, and the gas is produced by the chemical reaction that is brought about. In this FIG. 7, the size of the first chemical reaction space 30 is, for example, equivalent to 1-4 cc when the required hydrogen fuel is 140-150 cc per minute with a fuel cell output of 20 watts. For that, for example, the amount of a 6% by weight concentration borohydride solution is 0.6-0.9 cc, and to keep the concentration from being diluted over time and keep the chemical reaction rate constant (room temperature and normal pressure) at this time, the outflow to the second chemical reaction space is set (factor that determines the required amount of fuel supplied from the fuel system) 2-4 minutes afterwards. However, since there is bubbling at the actual chemical reaction site for the structure in this FIG. 6, the 1-4 cc described previously is multiplied by 5-10, and in other words, becomes 5-40 cc, with an example on the lower limit side of 7 cc shown. Optimization of this volume is based on the overall fuel cell system that is accommodated. The volume is estimated from trial calculations of the required chemical reaction rate and corrected based on the actual structure and bubbling state of the chemical reaction. It is minimized, but it is the most important element in the present invention for making the concentration constant.

FIG. 8 shows an example of a conventional gas generation and supply device for a portable fuel cell. This device is one that produces a chemical reaction, generates the gas and provides fuel to the fuel cell from the supply opening 300 by having a catalytic solution 11 a flow from a tube 22 and mix with a particulate material 21a when the solution storage body liquid 1 and the chemical reaction space storage body 2 are brought together at a joining part 200. However, using this means, the chemical phenomenon is one where as the reaction time progresses, the concentration of the catalytic solution 11a in the chemical reaction space is diluted over time by mixing with the reacted solution, and the rate of gas production drops. Therefore, for applications with continuous production and supply of a constant amount of gas, a separate storage chamber and regulator that adjusts the supply pressure are necessary.

FIG. 9 shows an example of test results on the amount of hydrogen gas generated by the present invention. The horizontal axis shows the elapsed time (in minutes) from the start of the chemical reaction of the hydrogen gas producing solution, and the vertical axis is the cumulative amount (cc) of hydrogen gas produced in that elapsed time. In the figure, curve A is an example where hydrogen gas was generated by having the chemical reaction in one space based on storage of a borohydride substance with 0.1 mole of acid at a rate of substantially 0.5 cc/min. One factor in the decrease in the hydrogen gas production rate that can be seen with the passage of time in the chemical reaction is dilution of the catalyst along with the reaction time. On the other hand, curve B is an example where 1 mole of acid and a 30% by weight borohydride solution at a rate of substantially 0.1 cc/min. were reacted first in the first reaction space (volume of approximately 5 cc), and the excess reaction liquid flowed into and stored in a second chemical reaction space having a larger volume (30 cc), with the chemical reaction continued in that space.

When these curves A and B are viewed from the standpoint of chemical reaction rate, it is proof of the effect of the present invention for maintaining the concentration of the solution at the reaction site with the elapse of time based on a prescribed concentration and mixing rate even though the test conditions for curves A and B are different

### EFFECTS OF THE EMBODIMENTS

According the these embodiments, a new path may be opened seamlessly for many applications as new forms regardless of whether they are portable or stationary for the supply of fuel to fuel cells for equipment having outputs from, for example, several watts or less to over several kilowatts. Furthermore, all of the embodiments shown here may be easily developed for a variety of applications based on the main variations shown here. In addition, there is the merit that with the present device, a regulator valve that adjusts the supply gas pressure from the constant amount of gas generated is unnecessary.

### OTHER EMBODIMENTS

With the embodiments in FIG. 1 through FIG. 7, it would be easy to develop applications according to the solutions used and the properties of the material for generating the fuel gas. Specifically, it is possible to mix the solution using a constant rate where the balloon function is replaced by gravity, for example, for operation in a fixed state for stationary applications. In, for example, the case of a fuel cell with a 20 watt chamber power within the reaction space, combining the mixture and chemical reaction rate, a structure where a first chemical reaction space with a hanging bell shape of at least one hydrophilic material cluster of a size of 10-20 mm in diameter or on one side and layered vertically is chemically reacted while falling and after passing through that space is further stored in a second chemical reaction space below it and gas continuously generated is not shown in the drawings, but it has the same concept.

Furthermore, even if the solution storage body 1 and the storage body 3 for the first chemical reaction space are in a state joined by the screw 34 in FIG. 5, it is easy to make the shaft 17e movable from the outside of the case 31 through the sealing material by manually pushing the ball 17a upwards when fuel gas is necessary. In addition, it is naturally possible to apply the use of the present invention to production of gases other than hydrogen.

### BRIEF DESCRIPTION OF THE DRAWINGS

FIG. 1 is a block diagram of a hydrogen gas generation and supply device that makes the chemical reaction rate for the particulate material constant in a first embodiment of the present invention.

FIG. 2 is a block diagram (embodiment 2) where the gas flow space in FIG. 1 is moved to the first chemical reaction space.

FIG. 3 is a block diagram (embodiment 3) where there is provided a solution infiltration material for limiting the chemical reaction surface area of the particulate material in FIG. 1.

FIG. 4 is a block diagram (embodiment 4) of a hydrogen gas generating and supply device that makes the chemical reaction rate for a solution constant instead of the particulate material of FIG. 1.

FIG. 5 is a block diagram (embodiment 5) where the gas flow space in FIG. 3 is moved to the first chemical reaction space.

FIG. 6 is a cross-sectional view (embodiment 1 block diagram) showing a structural example for FIG. 1.

FIG. 7 is a cross-sectional view (embodiment 4 block diagram) showing a structural example for FIG. 4.

FIG. 8 is a diagram of production of a constant amount of hydrogen showing an example of test results using the present invention.

FIG. 9 is a cross-sectional diagram showing a conventional hydrogen gas generation and supply device for portable fuel cells.

### EXPLANATION OF THE ELEMENTS

In the drawings,

1, 2 chemical reaction solution storage body

3 chemical reaction space storage body

10, 20 chemical reaction solution

14,24 balloon

13, 23, 33, 33e gas permeable material

13a, 23a, 33a structural material forming gas transmitting film

10a, 20a solution supply opening

16, 26 chemical reaction solution outlet

17d, 18, 27d, 28, 37a, 37b sealing material

17b, 27b narrowed part

17, 27 check valve

17a, 27a ball

17e, 27e shaft

15, 25, 30 chemical reaction space

12, 16c, 22, 26c, 30b, 32, 33d gas flow space

11, 21, 31 casing

16b, 26b, 30b gas permeable part

33c shaft support part

14a, 24a balloon holding ring

13b, 23b peripheral grooved ring

34, 35 storage body connecting screw part

38, 38a solution permeation limiting material

### DOCUMENT NAME: DRAWINGS

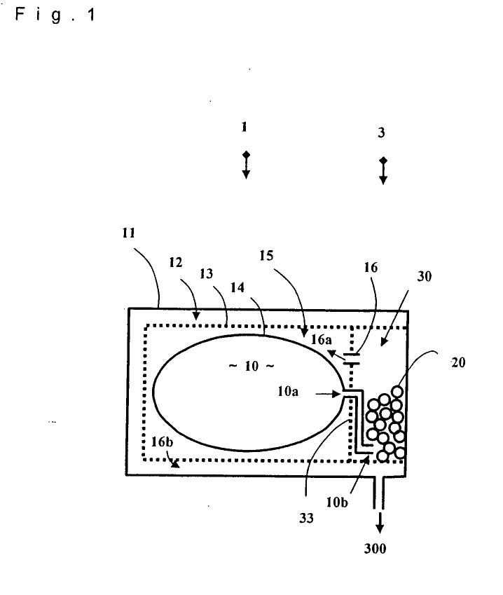

FIG. 1

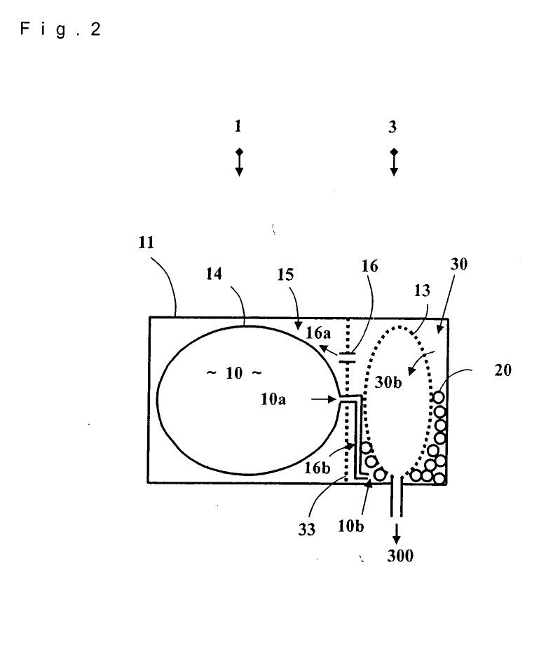

FIG. 2

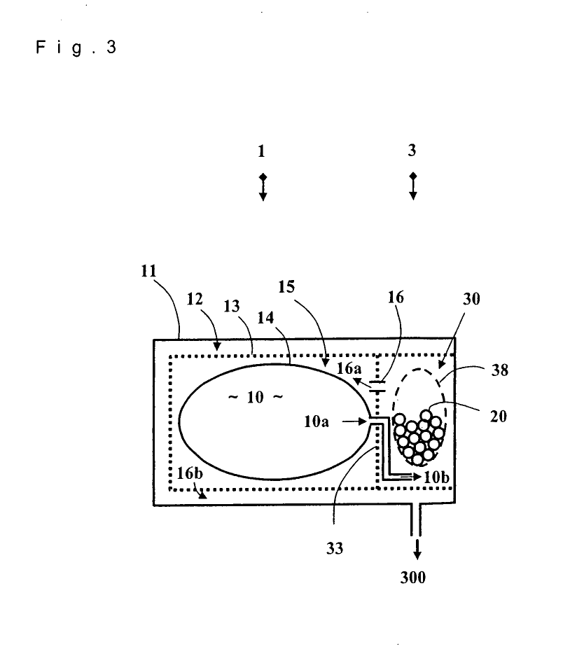

FIG. 3

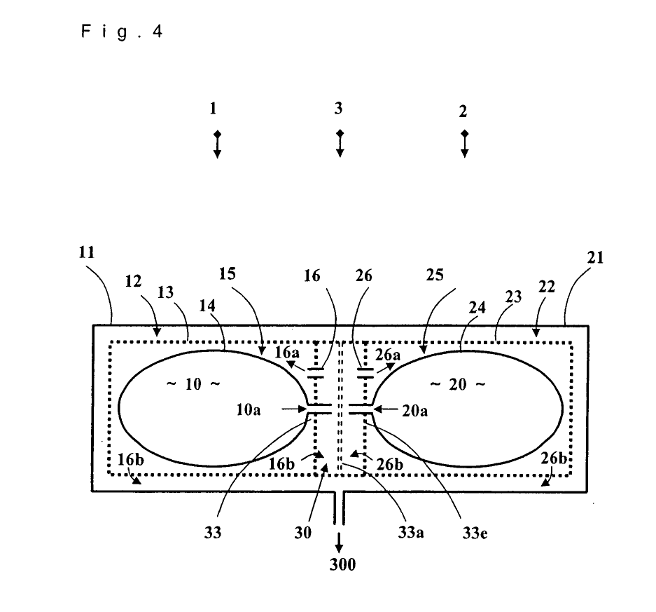

FIG. 4

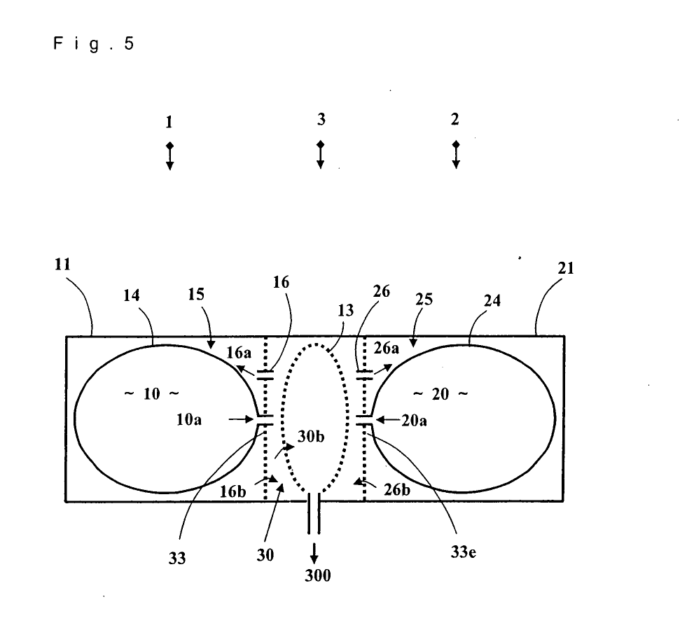

FIG. 5

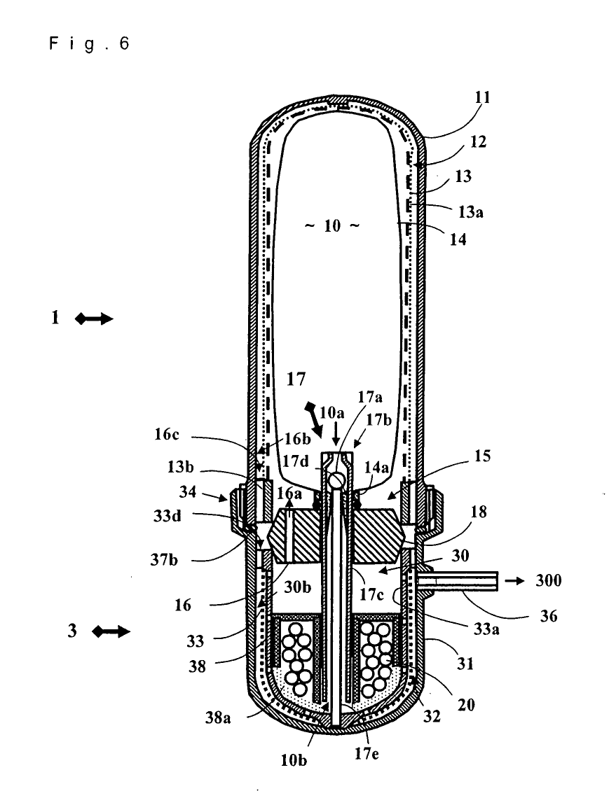

FIG. 6

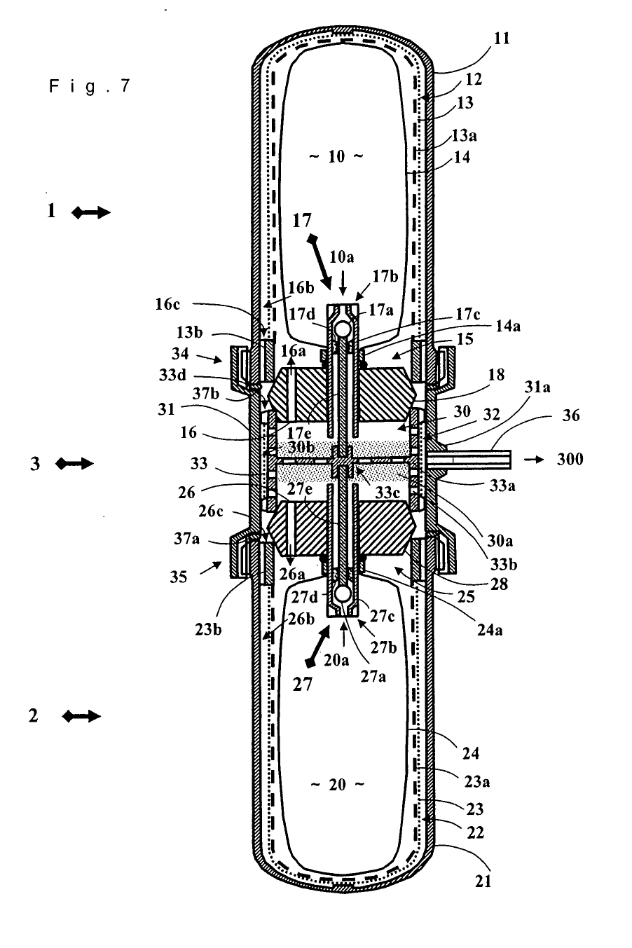

FIG. 7

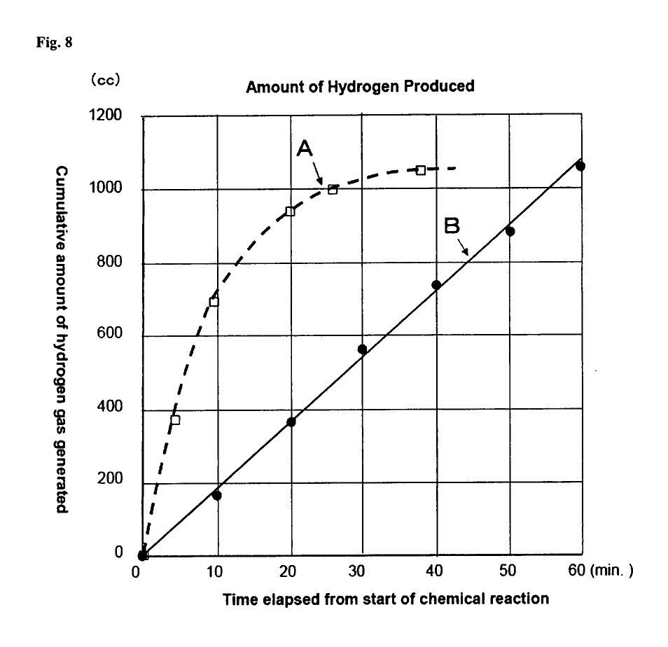

FIG. 8

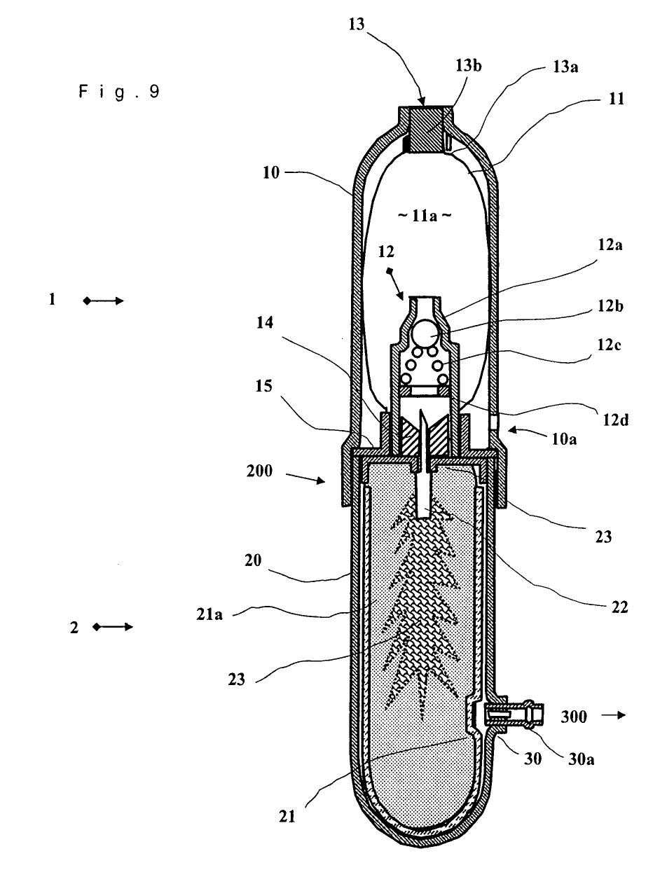

FIG. 9

1. A gas generation and supply device comprising a solution storage body housing a solution supply container capable of continuously supplying a solution at a constant rate, a particulate material that reacts chemically with said solution to generate a fuel gas, a storage body providing a first chemical reaction space having a volume smaller than said supply container, said reaction space containing said particulate material, a second chemical reaction space linked to said first chemical reaction space, a gas transmission element that prevents the passage of solution and allows said generated gas to pass through, and a gas flow space disposed to cause gas that has passed through the transmission element to flow to a fuel supply opening.

2. A gas generation and supply device as set forth in claim 1, including a supply outlet for said supply container disposed in spaced relationship relative to the place where the first and second chemical reaction spaces are linked.

3. A gas generation and supply device as set forth in claim 1, wherein said particulate material is contained in a material that limits the rate of solution permeation and thereby the rate of contact with said solution.

4. A gas generation and supply device comprising a first solution storage body housing a first solution supply container, a second solution storage body housing a second solution supply container, at least one of said containers being capable of continuously supplying a solution at a constant rate, a first chemical reaction space located for receiving said solutions from said containers and causing the same to become mixed so as to react and thereby generate a fuel gas, said first chemical reaction space being smaller in volume than at least one said containers, a second chemical reaction space linked to said first chemical reaction space, a gas transmission element that prevents the passage of solution and allows said generated gas to pass through, and a gas flow space disposed to cause gas that has passed through the transmission element to flow to a fuel supply opening.

5. A gas generation and supply device as set forth in claim 4, wherein a material having solution adsorption properties is provided in said first chemical reaction space.

6. A gas generation and supply device as set forth in claim 1, wherein the size within the first chemical reaction space is set as a function of the rate for said chemical reaction.

7. A gas generation and supply device as set forth in claim 1, wherein said solution storage body is housed within said second chemical reaction space.

8. A gas generation and supply device as set forth in claim 4, wherein the size within the first chemical reaction space is set as a function of the rate for said chemical reaction.

9. A gas generation and supply device as set forth in claim 4, wherein at least one of-said solution storage bodies is housed within said second chemical reaction space.
